(19) United States
(12) Patent Application Publication
(10) Pub. No.: US 2007/0126791 A1
(43) Pub. Date: Jun. 7, 2007

(54) INKJET IMAGE FORMING APPARATUS

(76) Inventors: Dong-woo HA, Suwon-si (KR); Jin-ho Park, Yongin-si (KR); Youn-gun Jung, Gunpo-si (KR)

Correspondence Address: STANZIONE & KIM, LLP, 919 18TH STREET, N.W., SUITE 440, WASHINGTON, DC, 20006, US

(21) Appl. No.: 11/535,192

(22) Filed: Sep. 26, 2006

(30) Foreign Application Priority Data
Dec. 2, 2005 (KR) 2005-116892

(51) Int. Cl. B41J 2/155

(52) U.S. Cl. 347/42

(57) ABSTRACT

An inkjet image forming apparatus. The inkjet image forming apparatus includes a platen to support a bottom side of paper. The platen includes a plurality of supporting portions facing the inkjet head to support a bottom side of a paper and a plurality of depressed portions depressed with a downward slope from sides of the supporting portions.

### CROSS-REFERENCE TO RELATED APPLICATIONS

This application claims the benefit of Korean Patent Application No. 10-2005-0116892, filed on Dec. 2, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus which maintains a constant gap between a sheet of paper and a nozzle unit.

2. Description of the Related Art

Inkjet image forming apparatuses form an image by ejecting ink from an inkjet head (e.g., shuttle type inkjet head) onto paper while reciprocating the inkjet head in a main scanning direction and feeding the paper in a subscanning direction. For high speed printing, inkjet image forming apparatuses can use an inkjet head (e.g., array inkjet head) with a nozzle unit having a length corresponding to a width of a paper in the main scanning direction instead of using the shuttle type inkjet head. In these inkjet image forming apparatuses, the array inkjet head is fixed, and only the paper is fed in the subscanning direction. Therefore, the inkjet image forming apparatus can have a simple driving mechanism and provide a high speed printing. In these image forming apparatuses, when a printing margin in a width direction of the A4 size paper is not considered, the nozzle unit should be about 210 mm long so as to correspond to the width of A4 size paper. When ink is ejected onto the paper, the paper may be wet and curled. If the paper, which is deformed by the curling, contacts the nozzle unit, the paper may be contaminated by ink, and the nozzle unit may be clogged by dust and foreign substances from a surface of the paper.

### SUMMARY OF THE INVENTION

The present general inventive concept provides an inkjet image forming apparatus that can effectively receive curled paper and prevent the curled paper from making contact with a nozzle unit.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an inkjet image forming apparatus including an inkjet head to eject ink, and a platen including a plurality of supporting portions facing the inkjet head to support a bottom side of a paper and a plurality of depressed portions recessed with a downward slope from sides of the supporting portions.

Each of the depressed portions may be sloped at an angle ranging between 20 degrees to 80 degrees with respect to a perpendicular line to the supporting portion. Each of the depressed portions may have a width and a depth that are larger at an exit end thereof than at a leading end thereof.

Each of the depressed portions may have a curved section with a tangential line extending from a side of the supporting portion, the tangential line making an angle ranging between 20 degrees to 80 degrees with respect to a perpendicular line to the supporting portion. The curved section may be a concave section. Each of the depressed portions may have a width and a depth that are larger at an exit end thereof than at a leading end thereof.

The inkjet head may be a shuttle type inkjet head which reciprocates in a width direction of the paper.

The inkjet head may be an array inkjet head provided with a nozzle unit having a length corresponding to a width of the paper in a main scanning direction. The nozzle unit may include a plurality of nozzle plates arranged in the main scanning direction, each of the nozzle plates having a plurality of nozzles. At least one of the depressed portions may correspond to the respective nozzle plates.

The foregoing and/or other aspects of the present general inventive concept are also achieved by providing a platen usable in an inkjet image forming apparatus, the platen including a plurality of supporting portions to form a paper supporting plane, the supporting portions extending along a paper transfer direction, and a plurality of depressed portions recessed from the paper supporting plane and extending along the paper transfer direction in between respective supporting portions.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates an inkjet image forming apparatus having an array type inkjet head according to an embodiment of the present general inventive concept;

FIG. 2 illustrates an example of a nozzle unit of the array type inkjet head of FIG. 1;

FIG. 3 illustrates an inkjet image forming apparatus having a shuttle type inkjet head according to an embodiment of the present general inventive concept;

FIG. 4 illustrates a perspective view of a platen of the inkjet image forming apparatuses illustrated in FIGS. 1 and 3;

FIGS. 5A and 5B are sectional views taken along a main scanning direction illustrating a depressed portion of the platen of FIG. 4;

FIG. 5C is a sectional view taken along a subscanning direction illustrating a depressed portion of the platen of FIG. 4;

FIG. 6 illustrates a wiping unit and a cap member usable in the inkjet image forming apparatus of FIG. 1;

FIG. 7 is a perspective view illustrating a guide path and a wiping path;

FIG. 8 illustrates a platen placed in a maintenance position;

FIG. 9 illustrates a nozzle unit capped by a cap member;

FIG. 10 illustrates paper supported by supporting portions of the platen before the paper is printed;

FIG. 11 illustrates paper supported by supporting portions and depressed portions of the platen when the paper is curled by ejected ink;

FIGS. 12A and 12B are sectional views taken along a subscanning direction illustrating operational effects depending on a depth and width of a depressed portion of the platen; and

FIGS. 13A and 13B are sectional views taken along a main scanning direction illustrating operational effects depending on a sloped angle of a depressed portion of the platen.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

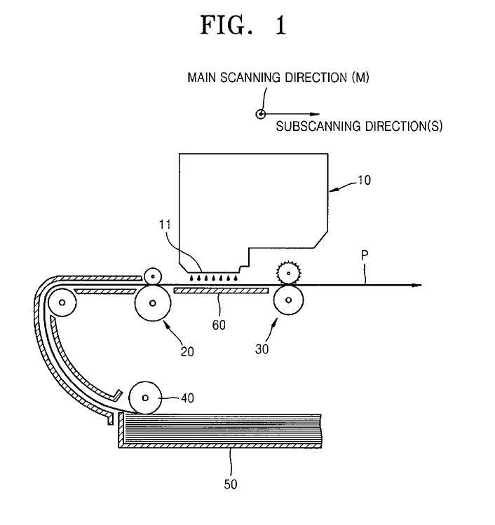

FIG. 1 illustrates an inkjet image forming apparatus according to an embodiment of the present general inventive concept. Referring to FIG. 1, a pick-up roller 40 picks up a sheet of paper (P) from a cassette 50 and a feed unit 20 feeds the paper (P) in a subscanning direction (S). An inkjet head 10 is installed above the paper (P) that is being fed. The inkjet head 10 includes a nozzle unit 11 having a length corresponding to a width of the paper (P) in a main scanning direction (M). The inkjet head 10 is an array type inkjet head that forms an image on the paper (P) by ejecting ink onto the paper (P) from a fixed position. The inkjet image forming apparatus further includes a platen 60 along which the paper (P) is fed underneath the nozzle unit 11 and a discharging unit 30 to discharge the paper (P) from underneath the nozzle unit 11.

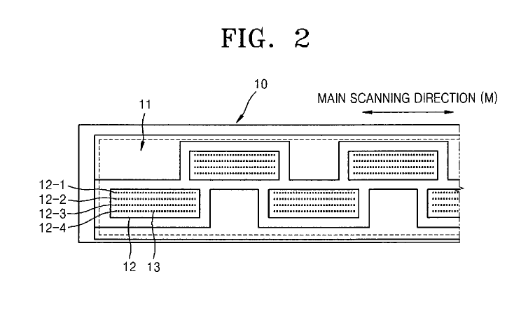

FIG. 2 illustrates an example of the nozzle unit 11 of the array type inkjet head 10. Referring to FIG. 2, the nozzle unit 11 includes a plurality of nozzle plates 12 staggered in the main scanning direction. Each of the nozzle plates 12 defines a plurality of nozzles 13 ejecting ink therethrough. The nozzle plate 12 may include a plurality of nozzle rows 12-1, 12-2, 12-3, and 12-4. Ink of the same color or different colors (e.g., cyan, magenta, yellow, and black) can be ejected through the respective nozzle rows 12-1, 12-2, 12-3, and 12-4. FIG. 2 illustrates only one example of many possible arrangements of the nozzle unit 11. That is, the present general inventive concept is not limited to the nozzle unit 11 illustrated in FIG. 2. Additionally, although not illustrated, the inkjet head 10 includes a chamber with an ink ejecting unit (e.g., a Piezo unit and/or a heater) in communication with each nozzle 13 to generate an ink-ejecting pressure, and an ink passage to supply ink to the chamber. The chamber, the ink ejecting unit, and the ink passage are well-known to those of skill in the art. Thus, detailed descriptions thereof will not be provided here.

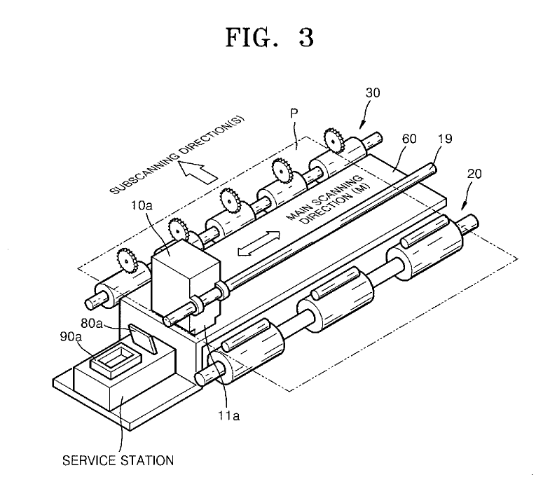

FIG. 3 illustrates an inkjet image forming apparatus having a shuttle type inkjet head 10a. The inkjet head 10a ejects ink onto paper (P) while reciprocating in a main scanning direction (M). The inkjet head 10a reciprocates in the main scanning direction (M) and is guided by a guide shaft 19. The inkjet head 10a includes a nozzle unit 11a provided with a plurality of nozzles. The inkjet head 10a also includes a chamber with an ink ejecting unit (e.g., a Piezo unit and/or a heater) in communication with each nozzle to generate an ink-ejecting pressure, and an ink passage to supply ink to the chamber. The inkjet image forming apparatus further includes a feed unit 20 (similar to the feed unit 20 in FIG. 1) to feed the paper (P), a platen 60 (similar to the platen 60 in FIG. 1) along which the paper (P) is fed underneath the nozzle unit 11a, a discharging unit 30 (similar to the discharging unit 30 in FIG. 1) to discharge the paper (P) from underneath the nozzle unit 11a, and a service station having a cap member 90a and a wiping unit 80a.

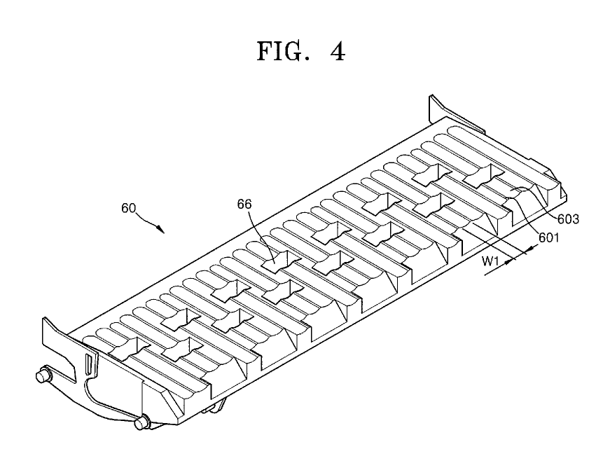

FIG. 4 illustrates a perspective view of the platen 60 of the inkjet image forming apparatuses illustrated in FIGS. 1 and 3. Referring to the embodiments of FIGS. 2 and 3, the platen 60 faces the nozzle unit 11/11a to support a rear side of the paper (P). The platen 60 is placed such that the nozzle unit 11/11a of the inkjet head 10/10a can be spaced a predetermined distance, for example, a distance of about 0.5 to about 2 mm, apart from the paper (P). The discharging unit 30 is installed at an exit end of the inkjet head 10/10a to discharge the paper (P) after printing.

Referring to FIG. 4, the platen 60 includes a plurality of supporting portions 601 to support the rear side of the paper (P) and a plurality of depressed portions 603 recessed from the supporting portions 601. The platen 60 employed in the inkjet image forming apparatus with the array type inkjet head 10 illustrated in FIG. 1 may include a plurality of containing portions 66. The containing portions 66 are arranged in correspondence with the nozzle plates 12 illustrated in FIG. 2 to receive spitted ink. When printing is not performed for a predetermined time or some of the nozzles 13 are not used for a predetermined time during printing, moisture in the ink evaporates and increases the viscosity of the ink, thereby causing ink ejecting errors. The term “spitting” refers to an operation of ejecting ink several times for removing viscous ink from the nozzles 13 (see FIG. 2). In the image forming apparatus with the shuttle type inkjet head 10a illustrated in FIG. 3, generally, the platen 60 need not be formed with the containing portions 66, since the spitting can be performed after the inkjet head 10a is moved to the service station.

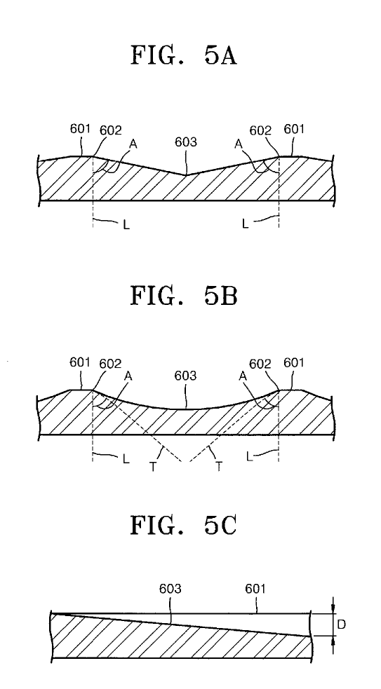

FIGS. 5A and 5B are sectional views taken along the main scanning direction illustrating the depressed portion 603 of the platen 60 of FIG. 4, and FIG. 5C is a sectional view taken along the subscanning direction illustrating the depressed portion 603 of the platen 60 of FIG. 4. The depressed portion 603, as illustrated in FIG. 5A, may be linearly sloped down from sides 602 of the neighboring supporting portions 601. In this case, an angle (A) between a line (L) perpendicular to the supporting portion 601 and the linearly sloped line of the depressed portion 603 (that is, an angle of the linearly sloped line measured counterclockwise from the perpendicular line (L)) may range between about 20 degrees to about 80 degrees. The depressed portion 603, as illustrated in FIG. 5B, may have a curved shape. In this case, an angle (A) between a line (T) tangential and the side 602 of the supporting portion 601 may range between about 20 degrees to about 80 degrees with respect to the perpendicular line (L). The curved shape of the depressed portion 603 may be concave. Further, as illustrated in FIGS. 4 and 5C, a width (W1) and a depth (D) of the depressed portion 603 measured at an exit end (a right side of FIG. 4) may be larger than a width and a depth of the depressed portion 603 measured at a leading end (a left side of FIG. 4). The width (W1) and depth (D) of the depressed portion 603 may increase when moving from the leading end of the platen 60 to the exit end of the platen 60.

In the image forming apparatus having the shuttle type inkjet head 10a as illustrated in FIG. 3, the wiping unit 80a and the cap member 90a are installed at the service station to wipe the nozzle unit 11a and cap the nozzle unit 11a. Therefore, the platen 60 supports the bottom of the paper (P) at a fixed position.

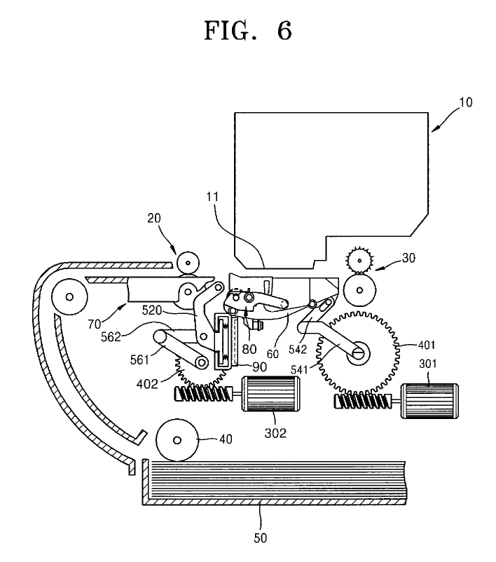

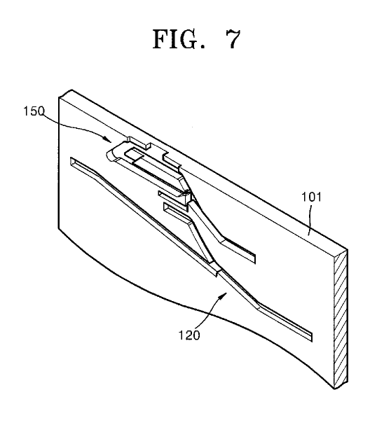

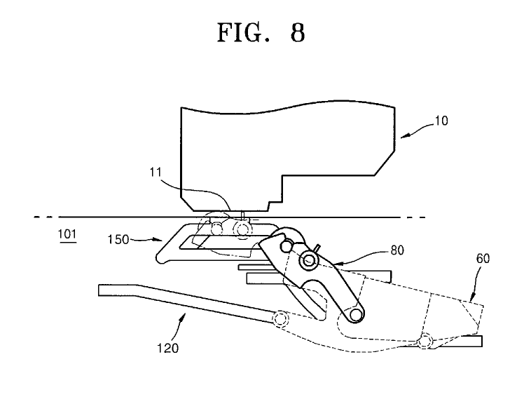

FIG. 6 illustrates a wiping unit 80 and a cap member 90 of the inkjet image forming apparatus of FIG. 1. Referring to FIG. 6, the image forming apparatus with the array type inkjet head 10 includes the wiping unit 80 to wipe the nozzle unit 11 and the cap member 90 to cap the nozzle unit 11. A first link arm 541 is coupled to a gear 401 which is rotated by a maintenance motor 301. A second link arm 542 connects the first link arm 541 and the platen 60. FIG. 7 illustrates a guide path 150 to guide the platen 60. The guide path 150 is formed in a frame 101 that supports the platen 60. As the maintenance motor 301 rotates in forward and reverse directions, the platen 60 is guided along the guide path 150 between a maintenance position illustrated in FIG. 8 and a printing position illustrated in FIG. 6. As illustrated in FIG. 6, the wiping unit 80 is coupled to the platen 60. While moving with the platen 60, the wiping unit 80 is guided by a wiping path 120 illustrated in FIG. 7 to wipe the nozzle unit 11, thereby removing foreign substances from the nozzle unit 11.

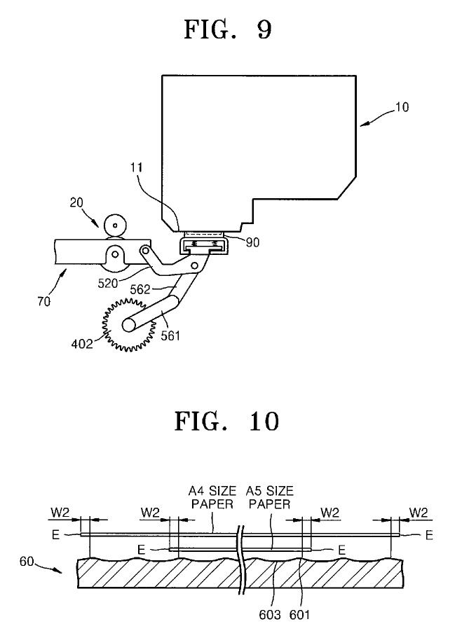

Referring to FIG. 6, the cap member 90 is coupled to a cap arm 520. The cap arm 520 is rotatably installed on a guide member 70 to guide paper under the nozzle unit 11. Third and fourth link arms 561 and 562 are rotated by a cap motor 302 and are connected between a gear 402 and the cap arm 520. When the platen 60 is placed in the maintenance position, the cap member 90 is moved between a capping position illustrated in FIG. 9 and an uncapping position illustrated in FIG. 6 by forward and reverse rotation of the cap motor 302.

Operational effects of the supporting portions 601 and the depressed portions 603 will now be described with reference to the image forming apparatus with the array type inkjet head 10 as illustrated in FIGS. 1 and 6. However, it should be understood that these operational effects also apply to the supporting portions 601 and the depressed portions 603 of the platen 60 of the image forming apparatus with the shuttle type inkjet head 10a.

Printing is performed when the platen 60 is placed in the printing position as illustrated in FIG. 6. When the inkjet head 10 ejects ink onto the paper (P), the paper (P) is dampened by moisture contained in the ink, and the paper (P) may be curled as a result. Particularly, since the array type inkjet head 10 ejects a large amount of ink with a short time when compared with the shuttle type inkjet head 10a, the possibility of the paper (P) curling increases, and a size of a curled portion of the paper (P) is larger. If the paper (P) extends upward from the platen 60 due to the curling, the paper (P) can contact the nozzle unit 11. In order to prevent this problem, as illustrated in FIGS. 4, 5A, 5B, and 5C, the platen 60 includes the plurality of supporting portions 601 to support the bottom of the paper (P) and the depressed portions 603 recessed between the sides 602 of the supporting portions 601. Here, in the image forming apparatus having the array type inkjet head 10, one or more depressed portions 603 may correspond to each nozzle plate 12 (see FIG. 2) in alignment with a center of the nozzle plate 12 (see FIG. 2).

Paper of various sizes can be used as a printing medium. Typically, A4, A5, LTR, LEGAL, or other size paper can be used in the image forming apparatuses of FIGS. 1, 3, and 6. When arranging the supporting portions 601, widths of the paper are considered. For example, in an image forming apparatus capable of using A4 and A5 size paper as regular size paper, as illustrated in FIG. 10, a distance W2 between each side edge (E) of the A4 size paper and the A5 size paper and an inner supporting portion 601 adjacent to the side edge (E) is about several millimeters. Therefore, an image can be printed at a high quality even on each edge (E) of the A4 and A5 size paper.

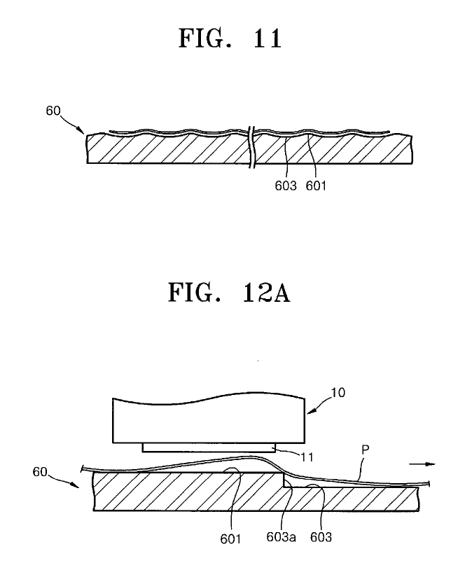

The paper (P) is fed under the nozzle unit 11 while being guided by the supporting portions 601. The inkjet head 10 ejects ink onto the paper (P). When the paper (P) is dampened by moisture of the ink after passing through the nozzle unit 11, the paper (P) is curled. As illustrated in FIG. 11, the curled paper (P) naturally rests on the plurality of supporting portions 601 and the depressed portions 603. If the depressed portions 603 are formed in a curved shape as illustrated in FIG. 5B, the curved shape may be concave to accommodate the curls of the paper (P).

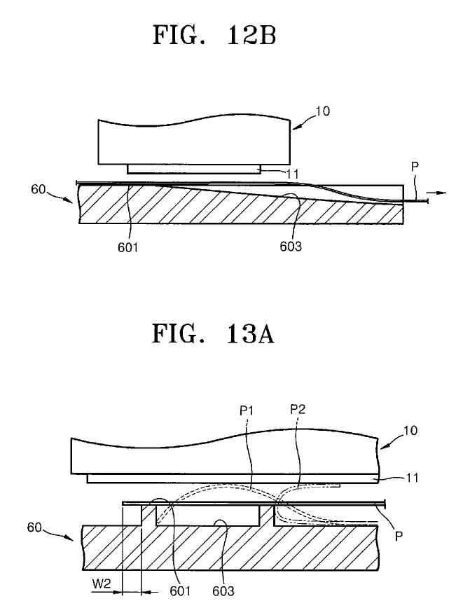

If the depressed portions 603 are formed in the platen 60 only at a portion corresponding to the exit end of the nozzle unit 11 as illustrated in FIG. 12A, a curl of the paper (P) may collide with an edge 603a of the depressed portion 603. In this case, the paper (P) extends upward from the supporting portion 601. As a result, a distance between the paper (P) and the nozzle unit 11 is decreased, thereby degrading printing quality. In a worst case scenario, the paper (P) may contact the nozzle unit 11. In an embodiment of the present general inventive concept, as illustrated in FIG. 5C, the depressed portion 603 is formed from the leading end to the exit end of the nozzle unit 11. Further, since the depth (D) of the depressed portion 603 at the exit end (i.e., the exit end of the nozzle unit 11) is larger than that of the depressed portion 603 at the leading end (i.e., the leading end of the nozzle unit 11), a curl of the paper (P) can be naturally accommodated in the depressed portion 603 to prevent the paper (P) from being lifted toward the nozzle unit 11. Further, referring to FIGS. 4 and 5A to 5C, since the width (W1) of the depressed portion 603 measured at the exit end is larger than that of the depressed portion 603 measured at the leading end, the paper (P) can be supported flat by the platen 60 at the leading end of the depressed portions 603, and curls of the paper (P) can be freely accommodated at the exit end of the depressed portions 603.

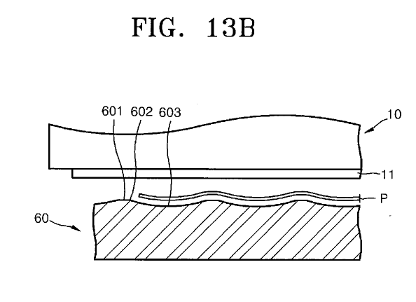

As illustrated in FIG. 13A, if the depressed portions 603 are recessed approximately in a vertical direction, the paper (P) as indicated with a solid line can be supported flat by the supporting portions 601, before ink is ejected onto the paper (P). Here, the distance (W2) between an edge of the paper (P) and the supporting portion 601 is about several millimeters, as described above. However, when the paper (P) is wet by the ejected ink, the paper (P) may be curled, and the edge of paper (P1) can be caught by a lower end of the supporting portion 601, as illustrated with a dashed line (P1). Then, the paper (P1) may be pushed toward the nozzle unit 11 to make contact with the nozzle unit 11. Particularly, in the shuttle type inkjet head 10a that reciprocates in the subscanning directions, a paper (P2) may be caught by a side of the inkjet head 10a and folded as illustrated with a one-dot chain line (P2), causing a paper jam. This problem may occur more frequently when the paper (P) is skewed while it is fed such that the distance (W2) between the edge of the paper (P) and the supporting portion 601 is decreased. In order to prevent this problem, the depressed portion 603 can be sloped down from the side 602 of the supporting portion 601 as illustrated in FIGS. 5A and 5B. In this case, the edge of the paper (P) is guided by the sloped depressed portion 603 as illustrated in FIG. 13B such that the paper (P) can be prevented from being pushed toward the nozzle unit 11 and the edge the paper (P) can be freely accommodated in the depressed portion 603. According to experiments performed while varying the sloped angle (A) of the depressed portion 603, the sloped angle (A) may range from 20 degrees to 80 degrees with respect to the perpendicular line (L) to the supporting portion 601.

As described above, according to an inkjet image forming apparatus of embodiments of the present general inventive concept, a platen includes depressed portions sloped down from supporting portions of the platen such that the platen can stably support a bottom of a sheet of paper having curls formed therein due to wet ink. Further, the platen can prevent edges of the paper from being caught by the supporting portions when the paper is curled or skewed. Therefore, a gap between the paper and a nozzle can be maintained constant such that stable printing quality can be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
an inkjet head to eject ink; and
a platen including a plurality of supporting portions facing the inkjet head to support a bottom side of a paper and a plurality of depressed portions recessed with a downward slope from sides of the supporting portions.

2. The inkjet image forming apparatus of claim 1, wherein each of the depressed portions is sloped at an angle ranging between 20 degrees to 80 degrees with respect to a perpendicular line to the supporting portion.

3. The inkjet image forming apparatus of claim 2, wherein each of the depressed portions has a width and a depth that are larger at an exit end thereof than at a leading end thereof.

4. The inkjet image forming apparatus of claim 1, wherein each of the depressed portions has a curved section with a tangential line extending from a side of the supporting portion, the tangential line making an angle ranging between 20 degrees to 80 degrees with respect to a perpendicular line to the supporting portion.

5. The inkjet image forming apparatus of claim 4, wherein the curved section is a concave section.

6. The inkjet image forming apparatus of claim 5, wherein each of the depressed portions has a width and a depth that are larger at an exit end thereof than at a leading end thereof.

7. The inkjet image forming apparatus of claim 1, wherein the inkjet head is a shuttle type inkjet head which reciprocates in a width direction of the paper.

8. The inkjet image forming apparatus of claim 1, wherein the inkjet head is an array inkjet head provided with a nozzle unit having a length corresponding to a width of the paper in a main scanning direction.

9. The inkjet image forming apparatus of claim 8, wherein the nozzle unit comprises a plurality of nozzle plates arranged in the main scanning direction, each of the nozzle plates having a plurality of nozzles, and at least one of the depressed portions corresponds to the respective nozzle plates.

10. A platen usable in an inkjet image forming apparatus, the platen comprising:
a plurality of supporting portions to form a paper supporting plane, the supporting portions extending along a paper transfer direction; and
a plurality of depressed portions recessed from the paper supporting plane and extending along the paper transfer direction in between respective supporting portions.

11. The platen of claim 10, wherein the depressed portions have a concave curve shape.

12. The platen of claim 10, further comprising:
a plurality of containing portions disposed therein to receive ink from a spitting operation.

13. The platen of claim 10, further comprising:
a sheet of paper having portions curled due to wet ink, the curled portions being accommodated in respective depressed portions.

14. The platen of claim 10, wherein sides of the supporting portions extend downward into the recessed portions at a non-perpendicular angle with respect to the supporting plane.

15. The platen of claim 10, wherein widths of the recessed portions gradually increase from an entrance end thereof to an exit end thereof.
